(19) United States
(12) Patent Application Publication
(10) Pub. No.: US 2002/0129624 A1
(43) Pub. Date: Sep. 19, 2002

(54) Methods and apparatus for the cooling of filaments in a filament forming process

(76) Inventors: Gary Gao, (US); Bruno A. Purnode, (US); David L. Molnar, (US); David J. Baker, (US); Timothy R. Gilbert, (US)

Correspondence Address: OWENS CORNING, 2790 COLUMBUS ROAD, GRANVILLE, OH, 43023, US

(21) Appl. No.: 09/730,277

(22) Filed: Dec. 5, 2000

(51) Int. Cl. C03B 37/10

(52) U.S. Cl. 65/430; 65/434; 65/443; 65/514

(57) ABSTRACT

Cooling systems and the methods of cooling filaments using the cooling systems are disclosed. One embodiment of the cooling system includes a layer of nozzles that spray air on the filaments above a pre-pad water spray. Alternatively, another cooling system utilizes air-atomizing nozzles to spray a mixture of air and water on the filaments.

The cooling systems provide an improved distribution of cooling fluid particulars to enhance the cooling of the filaments. The sprays from the nozzles have a higher momentum and are able to penetrate deeper into a filament fan than conventional cooling systems. The results are an improved temperature uniformity among the filaments and an overall reduction in temperature of the filaments prior to the application of size material.

### TECHNICAL FIELD AND INDUSTRIAL APPLICABILITY OF THE INVENTION

This invention relates to the cooling of filaments in a filament forming process, and in particular, to methods and apparatus for the cooling of filaments in a filament forming process. The invention is useful in the production of continuous glass filaments for use in a wide range of applications including textiles and reinforcements.

### BACKGROUND OF THE INVENTION

A strand of glass filaments is typically formed by attenuating molten glass through a plurality of orifices in a bottom plate of a bushing. The filaments are attenuated by applying tractive forces to the streams of glass, so as to attenuate the streams from the orifices in the bottom plate. The filaments pass into contact with pre-pad sprays and thereafter, are coated with a size or binder material. The size or binder material serves to provide a lubricating quality to the individual filaments to provide them with abrasion resistance or to impart a desired array of properties to the strand in its ultimate application. The size material is applied after the filaments are formed. The filaments are gathered in parallel relationship to form a strand.

The condition of the filaments prior to the application of the size material affects the efficiency and quality of the size application process. In conventional filament forming operations, solid or sticky sizing particles form at the points where the filaments contact the sizing film on the surface of a size applicator. The formation of these sizing particles is referred to as “plate out.” A leading cause of “plate out” is a high filament temperature at the point of contact on the size applicator.

“Plate out” that is not quickly remedied can lead to filament breaks, process interruptions, and lower glass filament forming efficiency. Accordingly, the size application process is affected by the temperature of the filaments as they contact the size applicator.

In addition to the temperature of the filaments at the size applicator, the size application process is affected by the moisture conditions of the filaments. Since many types of size material have some moisture content, the amount of moisture on the filaments determines how much size material is applied to and retained on the filaments.

High moisture content on the filaments upstream of the size applicator reduces the efficiency of the application of the size material. Too much moisture tends to dilute the size material picked up by the filaments. It also requires the size material on the size applicator to be constantly replenished, since the size application utilizes a closed system.

A high moisture content on the filaments also promotes migration-induced wastes. If there is too much moisture on the filaments, the size material will migrate along the filaments as the filaments are wound on a collet. As the filaments are wound, migration of the size material results in a higher concentration of the material at the ends of the package, thereby reducing the quality of the final product.

One proposed solution to the above problems is to coat the filaments with a pre-pad spray upstream of the size applicator. The pre-pad spray is usually applied by a pre-pad system that uses a nozzle. The pre-pad sprays serve multiple functions, including cooling the filaments and lubricating the filaments. Since too much moisture adversely affects the forming process, one solution is to use less pre-pad water. However, less pre-pad water with conventional systems results in less efficient cooling and higher filament temperatures.

Another proposed solution is to use air instead of applying pre-pad sprays of water. While using air instead of water as a pre-pad spray reduces the amount of moisture to be dried from the collected strand, the filaments are insufficiently cooled to reduce the likelihood of “plate out.”

A need exists for an apparatus for cooling glass filaments in a filament forming process that results in an improved temperature uniformity among filaments. Similarly, a need exists for an efficient filament forming method that maintains low forming moisture conditions and improves the application of size material on the filaments.

### SUMMARY OF THE INVENTION

The shortcomings of the prior art are overcome by the disclosed cooling systems and the methods of cooling filaments using the cooling systems. One embodiment of the cooling system includes one or more nozzles that direct a flow of air on the filaments above a pre-pad water spray. Alternatively, another cooling system utilizes air-atomizing nozzles to spray a mixture of air and water on the filaments.

The cooling systems provide an improved distribution of cooling fluid particles to enhance the cooling of the filaments. The sprays from the nozzles have a higher momentum and are able to penetrate deeper into a filament fan than conventional cooling systems. The results are an improved temperature uniformity among the filaments and an overall reduction in temperature of the filaments prior to the application of size material.

### BRIEF DESCRIPTION OF THE DRAWINGS

FIG. 1 is a schematic view of a filament forming system.

FIG. 2 is a schematic view of a cooling system embodying the principles of the invention.

FIG. 3 is a schematic view of an alternative embodiment of a cooling system.

FIG. 4 is a front view of the cooling system of FIG. 3.

FIG. 5 is a plan view of a cooling system embodying the principles of the invention.

FIG. 6 is a rear view of the cooling system of FIG. 5.

### DETAILED DESCRIPTION AND PREFERRED EMBODIMENTS OF THE INVENTION

A strand is typically formed from a group of filaments or fibers that are attenuated from a source of fiber-forming material. For glass strands, molten glass is delivered to a bushing that is electrically heated to maintain the glass in a molten state. The glass is pulled or attenuated as filaments from orifices in a bottom plate of the bushing.

The current trend is to operate bushings at higher temperatures and higher throughputs. While the goal is to produce more glass, these conditions result in undesirable side effects at the size applicator, such as filament breaks and process interruptions. Higher filament temperatures also increase the likelihood of degradation of material.

Conventional filament forming systems utilize pre-pad water sprays to cool filaments and provide lubrication to reduce contact point breaks. Since filaments tend to bundle together at the size applicator contact location, pre-pad sprays are used to enhance uniform lubrication.

The cooling system of the present invention utilizes less water to cool filaments than conventional pre-pad systems. Accordingly, less water is needed to cool the filaments to a particular temperature upstream of a size applicator. The result is a lower forming moisture process that improves size application efficiency. Another result is a lower consumption rate of water.

The effectiveness of a cooling system is related to the distribution of cooling fluid on the filaments and the ability of the cooling fluid to penetrate into the filament fan. Conventional cooling systems utilize nozzles that are unable to sufficiently penetrate the filament fan. Moreover, conventional nozzles provide inadequate coverage of cooling fluid on the filaments. Filaments that are conditioned by conventional cooling systems often have a non-uniform temperature distribution, which adversely affects the quality of resulting products.

The cooling system of the present invention enhances the reduction in temperature of the filaments. The system also reduces the variations in temperature within-position and position-to-position. Within-position temperature variations are the variations or averages that are obtained for a single forming position or bushing. Position-to-position temperature variations represent the differences from one bushing position to another along a particular forehearth.

The results achieved by the cooling system of the present invention are due to a balance between several factors, including: the flow rate of the cooling fluids, such as water and/or air; the nozzle locations; the angle at which the sprays are applied; and the spacing between nozzles. Regarding the nozzle locations, the nozzles should be far enough from the bushing to permit the filaments to sufficiently form. The nozzles should also be located far enough upstream from the size applicators to maximize the effect of the cooling fluid.

The angle at which the sprays are applied affects the depth of penetration of the filaments by the cooling fluid. Since a boundary layer is formed along the attenuated filaments, the penetration of the boundary layer and filament fan is a function of the direction of the sprays. When nozzles are oriented to blow from front to back across the filaments, much less air is carried with the filaments to the size applicator. If too much air is carried with the filaments, the size applicator may become dry, thereby adversely impacting the size application process.

The spacing between nozzles is determined by the spray coverage of each nozzle and the desired coverage of the filaments. The nozzles can be placed so that each nozzle's spray coverage overlaps that of another nozzle to a particular degree. This arrangement ensures that the filaments are covered with the cooling fluid.

Many of the “plate outs” discussed above occur inside the fiber fan and not at the edges. Trapped hot air inside the fiber fan contributes to the frequency of “plate outs.” The present invention includes a splitter shoe or comb between the size application and a gathering shoe to separate each fiber fan into several bundles or splits.

The use of nozzles to spray the cooling fluids provides several benefits. For example, the output or spray distribution from a nozzle is adjustable. The nozzle also provides the localization or the concentration of the cooling fluid on a particular area.

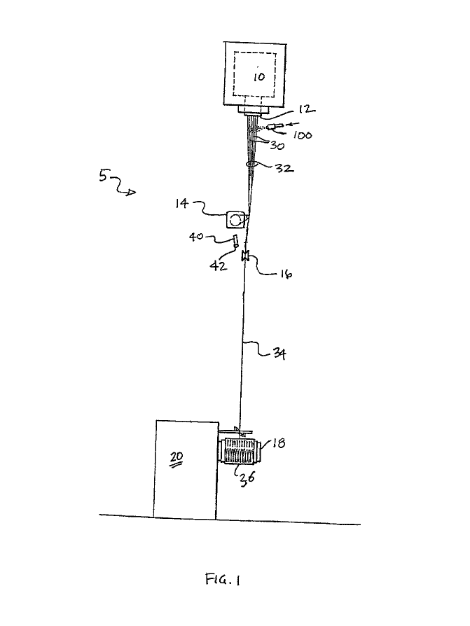

A filament forming system is shown in FIG. 1. The filament forming system 5 includes forehearth 10 and a bushing 12 having a plurality of orifices through which a plurality of streams of molten glass are discharged.

The filaments 30 are pulled downwardly by a winding apparatus 20 into a forming fan 32. The filaments 30 subsequently contact a size applicator 14 and a gathering shoe 16. The applicator 14 coats the filaments 30 with a size or binder material. The applicator 14 can be a belt applicator or any other conventional size applicator. The gathering shoe 16 gathers the filaments 30 into one or more strands 34. The strand 34 is wound onto a rotating collet 18 to form a package 36.

The filament forming system 5 includes a splitter shoe or comb 40 that is mounted on a rotating base 42. The comb 40 includes several teeth that separate the filaments into the desired number of strands. It will be appreciated that the base 42 can be rotated to move the comb 40 into and out of engagement with the filaments 30.

The filament forming system 5 includes a cooling system 100 that conditions the filaments 30 upstream of the size applicator 14. In the illustrated embodiment, the cooling system is a fluid spray system that directs a cooling fluid into engagement with the filaments 34.

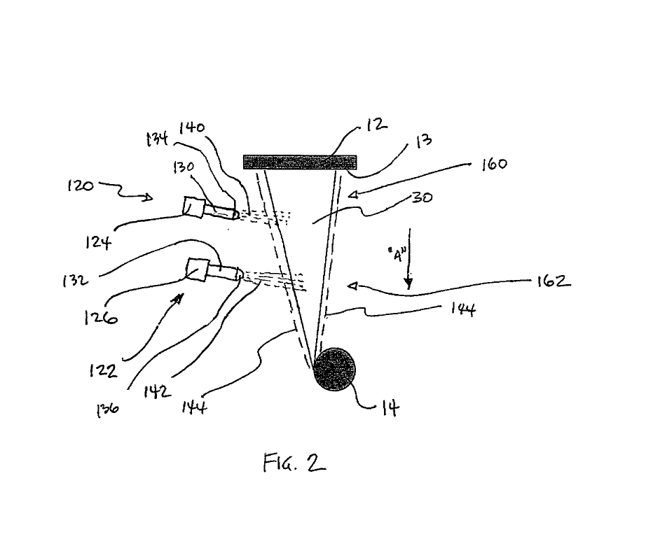

A cooling system 100 embodying the principles of the invention is illustrated in FIG. 2. As previously discussed, filaments 30 are attenuated from bushing 12 and subsequently contact size applicator 14. Filaments 30 are attenuated from the bushing 12 at very high rates of speed and have a high temperature. The filaments 30 are attenuated along the direction of arrow “A”, referred to as the attenuation direction. Filaments entrain air during formation. Accordingly, air is pulled into the filament fan as the filaments are attenuated. The temperature and the movement of the filaments creates a boundary layer 144.

The cooling system 100 illustrated in FIG. 2 includes multiple layers of nozzles 130, 132. Several nozzles 130 (only one shown) are located at a first position 120 with respect to the bushing bottom plate 13. Nozzle 130 is coupled to a manifold 124 which supplies a fluid to the nozzle 130. The nozzle 130 is oriented with its outlet port 134 directed at the filaments 30 in a first cooling region 160. During operation, the nozzle 130 directs spray 140 at the filaments.

Nozzles 132 are located at a second position 122 relative to the bushing 12. Nozzle 132 is coupled to a manifold 126 which supplies a fluid to the nozzle 132. The nozzle 132 is oriented with its outlet port 136 directed at the filaments 30 in a second cooling region 162. Spray 142 is directed at the filaments 130 from the second nozzle 132.

In the illustrated embodiment, the fluid supplied to nozzle 130 and forming spray 140 is air and the fluid supplied to nozzle 132 and forming spray 142 is water. The air cools the filaments and the water lubricates and further cools the filaments.

Preferably, the sprays 140, 142 are discharged from the nozzles 130, 132 with sufficient momentum to pass through the boundary layer 144 and contact the filaments 30. For example, the total flow volume through nozzles 130 is in the range of 16 to 24 gallons/hr and the total flow volume through nozzles 132 is in the range of 16 to 24 gallons/hr. A higher momentum can be achieved with compressed air in nozzles 130 than water in nozzles 132.

It will be appreciated that the distance between the nozzles 130, 132 may vary depending on the desired temperature changes. Similarly, the distance between the nozzles 130 and the bushing 12 and the distance between the nozzles 132 and the size applicator 14 may vary. The angle at which the nozzles 130, 132 are oriented with respect to the bushing bottom plate 13 may be adjusted.

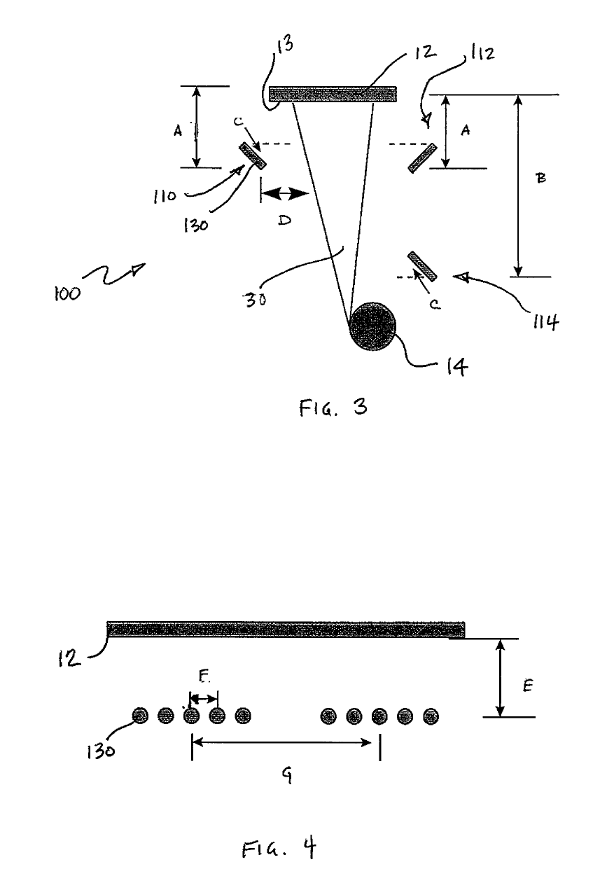

Another embodiment of a cooling system embodying the principles of the invention is illustrated in FIGS. 3 and 4. Filaments 30 are attenuated from the bottom plate 13 of the bushing 12. Front and rear sides of the filament forming system 5 are defined relative to the side of the size applicator 14 that the filaments 30 contact. The side of the size applicator 14 that the filaments 30 contact is referred to as the front of the forming system. Accordingly, the rear side of the filament forming system is on the opposite side of the size applicator.

Several nozzle positions are identified in FIG. 3. A primary front position 110 is shown on the front side of the filament forming system 5. A primary rear position 112 and a secondary rear position 114 are illustrated on the rear side of the system 5. Nozzles 130 are shown in each of the positions 110, 112, 114. It will be appreciated that nozzles can be provided in any combination of the positions 110, 112, and 114. For example, nozzles 130 may be located only in position 110.

Each of the nozzles 130 is mounted at an angle C with respect to a horizontal plane that is parallel to the bushing bottom plate 13. Angle C is typically in the range of 0 to 35°. It will be appreciated that this angle may vary for each nozzle for many reasons, including the type of filaments being attenuated, the desired disbursement of the sprays, the number of nozzles used, the positions in which the nozzles are located, etc.

The nozzles 130 in position 110 are preferably in alignment in a row as shown in FIG. 4. An exemplary arrangement of the nozzles is illustrated in FIG. 4. The nozzles 130 may be positioned in two or more groups depending on the desired spray distribution.

The following dimensions are utilized to further describe the cooling system illustrated in FIGS. 3 and 4. In this exemplary embodiment, nozzles 130 are located in position 110 only. The dimensions corresponding to the various reference letters are set forth below:

A=14 in. (35.6 cm)

C=0 degrees

D=3 in. (7.6 cm)

E=14 in. (35.6 cm)

F=1.75″ (4.5 cm)

G=11.25″ (28.5 cm)

It will be appreciated that the above dimensions can be varied to modify the distribution of the spray on the filaments. In an alternative embodiment, the A, C, and D dimensions can be varied depending on the type of nozzle used and the desired distribution of the spray. Some of the relevant dimensions are:

A=14 in. (35.6 cm)

C=15 degrees (up from a horizontal plane)

D=2 in. (5.1 cm)

Mist jet nozzles, discussed in greater detail below, may be utilized in this alternative embodiment.

An alternative embodiment of a cooling system embodying the principles of the invention is now described. In this embodiment, nozzles 130 are air-atomizing nozzles that spray a mixture of air and water. It will be appreciated that air-atomizing nozzles may also be used with a layer of air nozzles and/or water nozzles.

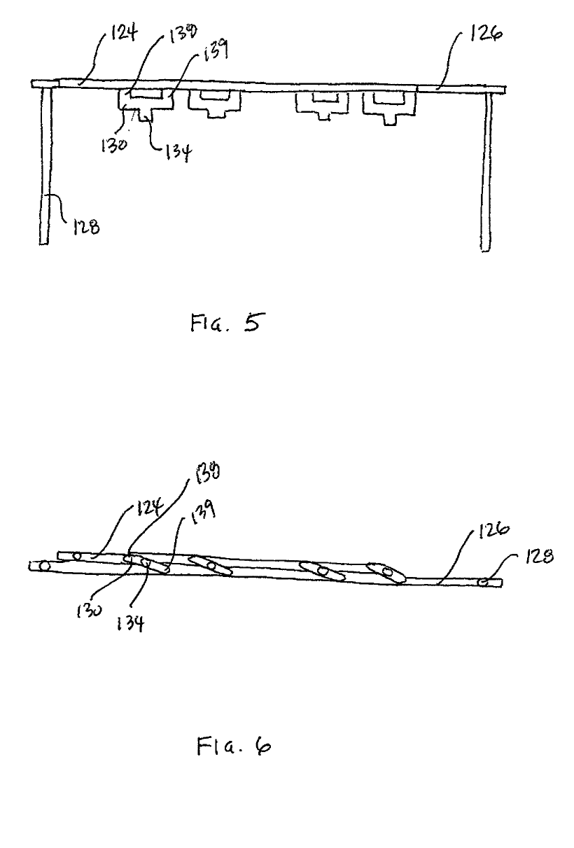

As illustrated in FIG. 5, nozzles 130 are fluidically coupled to manifolds 124, 126. Manifold 124 is connected to a compressed air supply (not shown) and to an inlet port 138 of the nozzles 130. Manifold 124 is connected to a pressurized water supply (not shown) and to another inlet port 139 of the nozzles 130.

The relative positions of the manifolds 124, 126 in this embodiment are illustrated in FIG. 6. Each nozzle 130 has an inlet port 138 coupled to manifold 124 and an inlet port 139 to manifold 126.

The degree of atomization of water achieved by air-atomizing nozzles is determined by the relative pressures and flow rates of the water and air. The water and air may be mixed either external to or inside the air-atomizing nozzle. Compressed air is used to atomize and drive the water sprays. An advantage of this nozzle is that spray momentum due to the air flow is separated from the water flow rate. As a result, deep penetration to the filament fan can be easily achieved using a low water volume. It will be appreciated that the atomization may be varied depending on the desired spray and particle size.

As discussed above, the filament forming system 5 includes a comb 40 that is movable into engagement with the filaments 30 to separate the filaments 30 into strands or bundles. As the bundles are separated apart, air can flow between the bundles of filaments 30 to cool them, thereby enhancing a deeper penetration of the filaments by the cooling fluid. The teeth on the comb can be designed to achieve a particular arrangement of bundles to maximize the effectiveness of the cooling spray systems.

Several different types of nozzles may be utilized to achieve the desired cooling and lubrication of the filaments. The preferred material for each of the nozzles and the manifolds is stainless steel.

One type of nozzle is a water-pressurized mist-jet nozzle. The mist-jet nozzle can be used to spray cooling water. An exemplary mist-jet nozzle is a hollow cone model A200 from Steinen Manufacturing Co. The mist-jet nozzle utilizes internal fluid pressure to atomize the fluid in the nozzle instead of a second fluid. A hollow cone spray pattern is essentially a circular ring of liquid. This pattern is generally formed by using an inlet tangential to a whirl chamber, or by an internal grooved vane immediately upstream from the orifice. The whirling liquid results in a hollow cone configuration as it leaves the output orifice.

Another type of nozzle is an external-mix, flat spray air-atomizing nozzle. An exemplary air-atomizing nozzle includes body model SUE 18A, fluid cap model 2050-SS and air cap model 62240-60 from Spraying Systems Co. in Wheaton, Ill. A flat spray nozzle distributes the spray with a flat- or sheet-type appearance. The sprays from this type of nozzle apply both air cooling and pre-pad water lubrication at the same time. Accordingly, more cooling can be accomplished with out increasing the applied pre-pad moisture. The flow rate and momentum of both air and water can be independently controlled.

Another type of nozzle is a compressed air nozzle. Some compressed air nozzles include: Vee-jet nozzles, Windjet nozzles, and blow-off nozzles. Each of these nozzles is operated by compressed air. Alternatively, the Vee-jet nozzle may be operated by pressurized water.

An exemplary Vee-Jet nozzle is model T800050 from Spraying Systems. Vee-jet nozzles apply a thin, flat spray coverage and are capable of applying higher spray momentum and wider spray angles. An exemplary Windjet nozzle is model 727 from Spraying Systems. This Windjet nozzle generates a controlled flat fan distribution of compressed air. The blow-off nozzles may be L type or P type blow-off nozzles from Spraying Systems Co.

Tests were conducted showing the effect that replacing conventional water pre-pad nozzles with different embodiments of the present invention has on temperature and other product characteristics. The process trials were run on various products using cooling methods of the present invention. Various product physical properties were evaluated.

The tests show that the use of the cooling systems of the present invention reduces filament temperature and reduces moisture, as is seen be referring to the Table below. The temperatures below are in degrees Fahrenheit. Forming moisture percent is determined by weighing the package directly off the collet. The package is then reweighed after drying to measure the amount of water that was originally in the package. The forming solids percent is the percent of the gross strand weight that is chemical applied to the filaments. The “T#” values represent the temperature readings at different thermocouples located in a row perpendicular to the direction in which the filaments are attenuated. T1 represents the left most temperature reading and T19 represents the right most temperature reading of the filament fan as viewed from the front side of the filament forming system. The other readings are located between the filament fan.

A first series of trials were conducted comparing conventional oil burner nozzles and mist-jet nozzles to apply a water spray on the filaments. A conventional standard oil burner nozzle setup was used in Trial 1 in Table A below. Trials 1-6 utilized two groups of four nozzles each. Trials 7-8 in Table A utilized two groups of five nozzles each.

The dimensions provided in Table A relate to the reference characters A and D illustrated in FIGS. 3 and 4. The angle values in Table A represent the angle of the nozzles relative to a horizontal plane parallel to the bushing bottom plate. The letters (d) and (u) represent angles down from or up above the horizontal plane, respectively. The spacing of the nozzles varied between Trials 1-6 and Trials 7-8. In Trials 1-6, the centers of the two groups of nozzles were approximately 11.25 inches apart. The distance between adjacent nozzles in a group was 2 inches. In Trials 7-8, the centers of the two groups of nozzles were approximately 11.25 inches apart and the distance between adjacent nozzles in a group was 1.75 inches.

The pressure values in the “Press (psi)” column represent the water pressure in the nozzles. In Trials 7 and 8, the pressure values represent those of the five nozzles in each group. For example, in Trial 7, three of the five nozzles in each group were operating at 95 psi and the other nozzles in the group were at 40 psi.

The volume indicated in the “Total Flow Volume (gph)” column represent the flow of water through the nozzles collectively. While the total flow volume for Trial 7 was 20 gph, the flow volume varied among the nozzles. The nozzles in each group had flow volumes of 1.5 gph, 2 gph, 3 gph, 2 gph, and 1.5 gph, with the 3 gph nozzle being the center nozzle in the arrangement. Similarly, the flow volumes of the nozzles in Trial 8 were 2 gph, 2.5 gph, 3 gph, 2.5 gph, and 2 gph. Finally, the mist-jet nozzles used were model A200 from Steinen Manufacturing, with the exception that in Trial 7, one of the nozzles with a pressure of 95 and flow volume of 1.5 gph was model A100 from Steinen.

TABLE A

| | | | | | Total | | | | | | | Strand |
|---|---|---|---|---|---|---|---|---|---|---|---|---|
| | A | | D | Press | Flow | | | | | | Mois | Solids |
| Trial | (in.) | Angle | (in) | (psi) | (gph) | T1 | T5/6 | T10 | T14/15 | T19 | % | % |
| 1 | 14 | 30 (d) | 3 | N/A | 24 | 105.6 | 115.6 | 100 | 118 | 102 | 13.49 | 0.75 |
| 2 | 14 | 0 | 3 | 65 | 20 | 105.4 | 158 | 99 | 118.9 | 102.7 | 13.21 | 0.74 |
| 3 | 14 | 0 | 3 | 95 | 24 | 106.3 | 107.4 | 100.4 | 110.3 | 101.1 | 13.93 | 0.81 |
| 4 | 16 | 30 (d) | 3 | 95 | 24 | 104.4 | 117.8 | 99.5 | 116.6 | 102.8 | 14.22 | 0.72 |
| 5 | 14 | 15 (u) | 3 | 95 | 24 | 96.8 | 107.8 | 96.4 | 99.2 | 99.3 | 13.98 | 0.81 |
| 6 | 14 | 30 (d) | 3 | 95 | 24 | 104 | 112.8 | 98.6 | 113 | 102.7 | 14.81 | 0.74 |
| 7 | 14 | 0 | 3 | 95,40, | 20 | 105.5 | 110.1 | 99.8 | 112.5 | 101.8 | 12.88 | 0.77 |
| | | | | 95,40, | | | | | | | | |
| | | | | 95 | | | | | | | | |
| 8 | 14 | 0 | 3 | 40,65, | 24 | 102 | 127 | 101 | 105 | 100 | 13.43 | 0.78 |
| | | | | 95,65, | | | | | | | | |
| | | | | 40 | | | | | | | | |

A second series of trials were conducted comparing a conventional pre-pad nozzles and flat-jet nozzles for air and water. The results of these trials are illustrated in Table B below.

In Trial 9, conventional pre-pad water spray nozzles were used. In Trials 10-13, flat-jet water nozzles were used instead of the conventional water spray nozzles. In Trials 14-20, the flat-jet air nozzles were used in addition to convention water spray nozzles.

The types of nozzle models and the nozzle arrangements varied in Trials 10-20. In Trials 10, 11, 14-16, 19, and 20, two groups of two nozzles each were used. The centers of the groups were located 11.25 inches apart. The centers of the nozzles in each group were 4.75 inches apart. In Trials 10, 11, and 14-16, nozzle model T8001 from Spraying Systems was used. In Trials 19 and 20, nozzle model T800050 from Spraying Systems was used.

In Trials 12 and 13, two groups of three nozzles each were used. The centers of the groups were located 11.25 inches apart. The centers of the nozzles in each group were 3 inches apart. The nozzles in each group for these two trials were model T800050 on the ends and model T8001 in the center.

In Trials 17 and 18, only two nozzles were used. The centers of the nozzles were spaced 11.25 inches apart. In these two trials, nozzle model T110010 from Spraying Systems was used.

In Trials 9-11 and 14-20, the total flow volume was evenly distributed to the nozzles in each group. In Trial 12, the flow volumes were 2.5 gph for the two end nozzles and 5 gph for the center nozzle. Similarly, in Trial 13, the flow volumes were 3 gph, 6 gph, and 3 gph.

TABLE B

| | | | | | Total | | | | | | | Strand |
|---|---|---|---|---|---|---|---|---|---|---|---|---|
| | A | | D | Press | Flow | | | | | | Mois | Solids |
| Trial | (in.) | Angle | (in) | (psi) | (gph) | T1 | T5/6 | T10 | T14/15 | T19 | % | % |
| 9 | 14 | 30 (d) | 3 | N/A | 24 | 108.5 | 119.8 | 100 | 119 | 104 | 13.17 | 0.69 |
| 10 | 14 | 0 | 3 | 45 | 20 | 222.9 | 289.7 | 157.4 | 279 | 196 | 7.26 | 0.68 |
| 11 | 14 | 0 | 3 | 60 | 24 | 199 | 203.4 | 150 | 185 | 175 | 9.02 | 0.73 |
| 12 | 14 | 0 | 3 | 45 | 20 | 205 | 223 | 134 | 187 | 167 | 9.08 | 0.73 |
| 13 | 14 | 0 | 3 | 60 | 24 | 177.5 | 174 | 122 | 139 | 162 | 9.87 | 0.75 |
| 14 | 11.5 | 28 (d) | 6.5 | 30 | 24 | 109.5 | 109.7 | 95.5 | 117 | 99 | 13.23 | 0.7 |
| 15 | 11.5 | 28 (d) | 6.5 | 10 | 24 | 110 | 112.3 | 97 | 121 | 105.2 | 13.11 | 0.69 |
| 16 | 17.5 | 25 (d) | 3 | 30 | 24 | 101.7 | 120.5 | 99 | 121 | 99 | 14.13 | 0.74 |
| 17 | 11 | 18 (d) | 8 | 30 | 24 | 102.3 | 107.8 | 101 | 101 | 104 | 14.65 | 0.75 |
| 18 | 11 | 18 (d) | 8 | 10 | 24 | 104.3 | 113.4 | 100.1 | 105.9 | 105.2 | 14.2 | 0.71 |
| 19 | 11.5 | 26 (d) | 6.5 | 50 | 24 | 108 | 106.1 | 98 | 110 | 100 | 13.59 | 0.7 |
| 20 | 11.5 | 26 (d) | 6.5 | 95 | 24 | 107.7 | 102.4 | 99.9 | 104.2 | 101.1 | 14.06 | 0.73 |

A third series of trials were conducted comparing conventional pre-pad water spray nozzles and air-atomizing nozzles. The results of these trials are illustrated in Table C below.

In Trial 21, conventional pre-pad water spray nozzles were used. In Trials 22-33, twin-fluid air-atomizing nozzles were used instead of the conventional water spray nozzles.

The nozzle models and the nozzle arrangements varied in Trials 22-33. In Trials 22-30, two groups of two nozzles each were used. The two groups of nozzles were spaced 7 inches apart. The centers of the nozzles in each group were 4.25 inches apart. In Trials 22-27, nozzle model A2050 from Spraying Systems Co. was used. In Trials 28-30, nozzle model A1650 from Spraying Systems was used.

In Trials 31-33, one group of two nozzles and one group of three nozzles were used. The centers of the groups were located 11.25 inches apart. In the groups of two nozzles, the centers of the nozzles were 4.25 inches apart. In the groups of three nozzles, the centers of the nozzles were 3 inches apart. For reasons of simplicity, the group of two nozzles is referred to as the left group and the group of three nozzles is referred to as the right group, from the perspective of the front side of the system, as described above.

In Trial 31, the left and right nozzles were model A1650. In Trial 32, the left and right nozzles were model A1450. In Trial 33, the left nozzles were model A1650 and the right nozzles were model A1450.

The pressure information in Table C includes two numbers for the trials. The first number is the water pressure in psi and the second number is the air pressure in psi.

In Trials 31-33, data was collected regarding the left and right filament fans. In Trials 31 and 32, the same water and air pressures were used in the left and right groups of nozzles. In Trial 33, the water and air pressures for the left group of nozzles directed at the left filament fan were 65 and 15 psi, respectively. The water and air pressures for the right group of nozzles were 95 and 15 psi, respectively.

In Trials 31-33, the total flow volumes to the left and right groups of nozzles are represented by 7 and 10.5 gph, respectively. Finally, the moisture percentage and the strand solids percentage for each of the fans is separately indicated with the first value corresponding to the left fan and the second value corresponding to the right fan.

TABLE C

| | | | | | Total | | | | | | | Strand |
|---|---|---|---|---|---|---|---|---|---|---|---|---|
| | A | | D | Press | Flow | | | | | | Mois | Solids |
| Trial | (in.) | Angle | (in) | (psi) | (gph) | T1 | T5/6 | T10 | T14/15 | T19 | % | % |
| 21 | 14 | 30 (d) | 3 | N/A | 24 | 104.5 | 113.6 | 100.1 | 120.2 | 104 | 14.9 | 0.67 |
| 22 | 13.75 | 0 | 4 | 68/20 | 20 | 100.7 | 90.5 | 106.4 | 93.7 | 100 | 11.24 | 0.79 |
| 23 | 13.75 | 0 | 4 | 40/20 | 16 | 113 | 110 | 98.5 | 92.1 | 112 | 10.96 | 0.78 |
| 24 | 13.75 | 0 | 8 | 68/20 | 20 | 96.7 | 94.9 | 89.4 | 87.6 | 96.4 | 11.62 | 0.78 |
| 25 | 13.75 | 0 | 8 | 95/20 | 24 | 93 | 88 | 84.9 | 84.5 | 92.7 | 11.93 | 0.87 |
| 26 | 10 | 0 | 8 | 68/20 | 20 | 97 | 81.6 | 81.1 | 83 | 98 | 11.60 | 0.86 |
| 27 | 10 | 0 | 8 | 95/20 | 24 | 108.4 | 82.7 | 80.7 | 92 | 108 | 11.48 | 0.86 |
| 28 | 13.75 | 0 | 4 | 95/20 | 17 | 101.1 | 85.6 | 92.2 | 100.5 | 116.4 | 11.24 | 0.84 |
| 29 | 13.75 | 0 | 4 | 95/15 | 17 | 130.4 | 109.4 | 119 | 149 | 150 | 10.48 | 0.8 |
| 30 | 13.75 | 0 | 4 | 65/15 | 14 | 127 | 98 | 94 | 109 | 131 | 11.02 | 0.81 |
| 31 | 13.75 | 0 | 4 | 65/15; | 7; | 98.7 | 89.9 | 97.4 | 131 | 164 | 10.12; | 0.81; |
| | | | | 65/15 | 10.5 | | | | | | 11.2 | 0.86 |
| 32 | 10 | 0 | 6.5 | 95/20; | 7; | 92 | 92.7 | 103.9 | 94 | 94.5 | 10.9; | 0.85; |
| | | | | 95/20 | 10.5 | | | | | | 11.4 | 0.86 |
| 33 | 10 | 0 | 6.5 | 65/15; | 7; | 128 | 123 | 122 | 117 | 98 | 10.38; | 0.8; |
| | | | | 95/15 | 10.5 | | | | | | 10.74 | 0.78 |

It will be appreciated that there are many variations on the particular embodiments discussed above that would be consistent with the principles of the invention.

For example, in a cooling system with nozzles at multiple positions, the first fluid sprayed on the filaments can be water and the second fluid sprayed on the filaments can be air.

The number of nozzles in a particular layer or level of the cooling system may vary depending on the area of filaments to be cooled, the arrangement of the bushing bottom plate, etc.

The bushing and its bottom plate may have an annular configuration.

Another cooling fluid other than water or air may be used so long as the integrity of the filaments and the filament forming process is maintained.

The spacing of nozzles in a particular row can be centered on a bottom plate of the bushing. The nozzle may be symmetrical about the center of the bottom plate as well. The nozzles may be equally spaced apart. Alternatively, the spacing between nozzles may be non-uniform for various reasons, including anticipated heating patterns of the filaments in a fan, etc.

The flow rate of cooling fluid may be uniform for all nozzle in a particular nozzle position. Alternatively, the flow rate may vary among the nozzles. For example, since the center region of a filament fan is typically warmer than the edges of the fan, the nozzles directed at the center region may spray cooling fluid at a higher momentum and higher flow rate than nozzles at the edges.

The size material can be applied with a size applicator other than a pad or belt arrangement. For example, the size material may be sprayed onto the filaments which subsequently contact a surface which collects the excess size material that has been sprayed.

The cooling system of the present invention provides a greater temperature reduction in the filaments than a conventional pre-pad spray system. The temperature uniformity of the filaments attenuated from a single bushing and of the filaments attenuated from multiple bushings on a forehearth is enhanced.

The cooling system of the present invention achieves a better uniform fluid distribution on the filaments. These nozzles also provide a finer particle size, which results in less water consumed during the cooling process. As a momentum of a spray at discharge increases, the penetration into the boundary layer adjacent the filaments increases, thereby providing a more uniform coverage. An end result is that a lower filament temperature can be achieved using less cooling fluid.

We claim:

1. An apparatus for cooling filaments in a filament forming process comprising:
a first nozzle located at a first position, said first nozzle directing a first fluid at the filaments; and
a second nozzle located at a second position, said second nozzle directing a second fluid at the filaments, wherein said first fluid is different from said second fluid, and said first nozzle and said second nozzle are positioned to direct said first fluid and said second fluid at the filaments upstream of a size applicator in the filament forming process.

2. The apparatus of claim 1, wherein the filaments are attenuated from a bottom plate of a bushing, and said first position is closer to the bottom plate than said second position.

3. The apparatus of claim 1, wherein said first fluid is air and said second fluid is water.

4. The apparatus of claim 1, wherein said second fluid is a mixture of air and water.

5. The apparatus of claim 4, wherein said second nozzle is an air-atomizing nozzle.

6. The apparatus of claim 3, further comprising:
a first manifold, said first nozzle being coupled to said first manifold; and
a second manifold, said second nozzle being coupled to said second manifold, wherein air is conveyed in said first manifold and water is conveyed in said second manifold.

7. An apparatus for cooling filaments in a filament forming process, the filaments attenuated from a bottom plate of a bushing, the filaments subsequently contacting a size applicator, the apparatus comprising:
a first nozzle disposed to direct a first fluid at the filaments, said fluid being a mixture of water and air.

8. The apparatus of claim 7, further comprising:
a second nozzle located at a second position, said second nozzle directing a second fluid at the filaments, wherein said first fluid is different from said second fluid.

9. The apparatus of claim 8, wherein said second fluid is air.

10. The apparatus of claim 9, wherein said second position is located upstream of said first position along the direction in which the filaments are attenuated.

11. The apparatus of claim 10, further comprising:
a first manifold coupled to said first nozzle; and
a second manifold coupled to said first nozzle, wherein air is conveyed in said first manifold and water is conveyed in said second manifold.

12. The apparatus of claim 7, further comprising:
a bushing having a generally planar bottom plate; and
a size applicator.

13. The apparatus of claim 12, wherein said first nozzle is directed toward a filament forming region between said bottom plate and said size applicator and in a direction downstream along the filaments relative to a plane parallel to said bushing bottom plate.

14. The apparatus of claim 13, wherein said first nozzle is oriented at an angle relative said plane, the angle being in the range of 0 to 35 degrees.

15. A method of forming continuous filaments, the filaments being attenuated from a bottom plate of a bushing in an attenuation direction, the filaments subsequently contacting a size applicator, the method comprising the steps of:
directing a first fluid at the filaments from a first nozzle located at a first position; and
directing a second fluid at the filaments from a second nozzle located at a second position, wherein the first position and the second position are located between the bushing and the size applicator along the attenuation direction, and the first fluid and the second fluid are different fluids.

16. The method of claim 15, wherein said first position is closer to the bottom plate than said second position.

17. The method of claim 16, wherein said first fluid is air.

18. The method of claim 17, wherein said second fluid is water.

19. The method of claim 16, wherein said second fluid is a mixture of air and water.

20. The method of claim 15, wherein said directing a first fluid includes directing said first fluid with a plurality of nozzles, each of said nozzles directing said first fluid at a different flow rate.

21. A method of cooling filaments attenuated from the bottom plate of a bushing and drawn through a filament cooling region into contact with a size applicator, the method comprising:
atomizing water with pressurized air; and
directing a flow of said atomized water into the filament cooling region with a pressure and at a flow rate sufficient to cool filaments in the filament cooling region below a predetermined temperature while maintaining a moisture level on the filaments below a predetermined value.

22. The method of claim 21, wherein the filaments are drawn in the form of a fan, said fan having a front side and a rear side relative to the contact point of the filaments on the size applicator, said front side corresponding to the side of the size applicator which the filaments contact, said directing a flow of said atomized water including directing said flow from said front side to said rear side.

23. The method of claim 21, wherein said directing a flow of said atomized water includes directing said flow of atomized water with a plurality of nozzles, each of said nozzles directing said flow of atomized water at a different flow rate.

24. A method of cooling filaments attenuated from the bottom plate of a bushing and drawn through a filament cooling region into contact with a size applicator, the method comprising:
directing a flow of air into a first cooling region through which the filaments are drawn;
directing a spray of water into a second cooling region through which the filaments are drawn, said second cooling region being spaced from said first cooling region.

25. The method of claim 24, wherein said second cooling region is downstream along the filaments from said first cooling region.

26. The method of claim 25, wherein said air and said water are sprayed on the same side of the filaments.

27. The method of claim 24, wherein said directing a flow of air includes directing air with a plurality of nozzles, each of said nozzles directing said air at a different flow rate.
